(19) United States
(12) Patent Application Publication
(10) Pub. No.: US 2026/0040121 A1
(43) Pub. Date: Feb. 5, 2026

(54) METHOD, APPARATUS AND COMPUTER PROGRAM

(71) Applicant: Nokia Technologies Oy, Espoo (FI)

(72) Inventors: Rafael CAUDURO DIAS DE PAIVA, Aalborg (DK); Erika PORTELA LOPES DE ALMEIDA, Aalborg SV (DK); Lars DALSGAARD, Oulu (FI); Samantha CAPORAL DEL BARRIO, Aalborg (DK)

(73) Assignee: Nokia Technologies Oy, Espoo (FI)

(21) Appl. No.: 19/119,229

(22) PCT Filed: Oct. 10, 2022
(86) PCT No.: PCT/EP2022/078055

§ 371 Date: Apr. 8, 2025

(51) Int. Cl. H04W 24/10

(52) U.S. Cl. CPC H04W 24/10

(57) ABSTRACT

There is provided an apparatus comprising: means for retrieving a configuration for a time window to perform network measurements in; means for associating the time window with a first receive element of a user equipment; and means for, during the time window, performing a network measurement using the associated first receive element and receiving downlink data using a second receive element of the user equipment.

### FIELD

The present application relates to a method, apparatus, and computer program for a wireless communication system.

### BACKGROUND

A communication system may be a facility that enables communication sessions between two or more entities such as user terminals, base stations/access points and/or other nodes by providing carriers between the various entities involved in the communications path. A communication system may be provided, for example, by means of a communication network and one or more compatible communication devices. The communication sessions may comprise, for example, communication of data for carrying communications such as voice, electronic mail (email), text message, multimedia and/or content data and so on. Non-limiting examples of services provided comprise two-way or multi-way calls, data communication or multimedia services and access to a data network system, such as the Internet.

### SUMMARY

According to an aspect, there is provided an apparatus comprising: means for retrieving a configuration for a time window to perform network measurements in; means for associating the time window with a first receive element of a user equipment; and means for, during the time window, performing a network measurement using the associated first receive element and receiving downlink data using a second receive element of the user equipment.

In an example, the first and second receive elements are separate receive chains of the user equipment. In an example, spatial configurations of the first and second receive elements are different.

In an example, the first and second receive elements comprise means for to receiving and decoding signals received by one or more antenna panels of the user equipment.

In an example, the downlink data is received without scheduling restrictions over the duration of the time window, such that downlink data is able to be received throughout the duration of the time window using the second receive element.

In an example, the apparatus comprises: means for receiving, from a network node, information associating the configuration of a time window for network measurement with a network transmit beam index for downlink.

In an example, the apparatus comprises: means for receiving, from a network node, information associating the activation of the time window for network measurement and a network transmit beam index for downlink.

In an example, the network transmit beam index for downlink is a transmission configuration information state.

In an example, the apparatus comprises: means for receiving a configuration for a further time window to perform network measurements in; means for associating the further time window with the second receive element of the user equipment; and means for performing a network measurement during the further time window using the associated second receive element.

In an example, the time window comprises a plurality of time occasions.

In an example, the time occasions comprise one or more symbols.

In an example, the time window is an SMTC window.

In an example, the apparatus comprises: means for assigning each of the plurality of time occasions of the time window for at least one of: the receiving of data, and the performing of network measurements; and means for performing at least one of: i) the reception data using at least one of: the first receive element, and the second receive element, and ii) network measurements using at least one of: the first receive element and the second receive element, during the time window, according to the assigning in each of the plurality of time occasions.

In an example, the means for associating comprises: means for associating the time window with: i) the first receive element of a user equipment, and ii) a second receive element of the user equipment.

In an example, the means for assigning comprises: means for assigning each of the plurality of time occasions of the time window for at least one of: the reception of data, and the performance of network measurements, using at least one of: the first receive element, and the second receive element of the user equipment.

In an example, for a time occasion of the plurality of time occasions, one of the first receive element and the second receive element is assigned for the reception of data, and the other of the first receive element and the second receive element is assigned for performing of network measurements.

In an example, for a time occasion of the plurality of time occasions, both the first receive element and the second receive element are assigned for one of: the reception of data, and the performing of network measurements.

In an example, the assignments for the reception of data, and the performing of network measurements, for both the first receive element and the second receive element, alternate between each time occasion in the time window.

In an example, for the time window, one of the first receive element and the second receive element is assigned for one of: the reception of data, and the performing of network measurements.

In an example, the time window comprises a synchronisation signal block-based measurement timing configuration, SMTC, window.

In an example, the means for retrieving comprises: means for receiving, from a network node, the configuration for the time window in a radio resource control reconfiguration message, wherein the configuration comprises information of the first receive element, and an indication that the first receive element is associated to network measurements, and wherein the configuration comprises information of the second receive element, and an indication that the second receive element is associated to downlink data reception.

In an example, one of: the apparatus is for the user equipment, the apparatus is comprised in the user equipment, and the apparatus is the user equipment.

According to an aspect, there is provided an apparatus comprising: means for providing, to a user equipment, a configuration for a time window to perform network measurements in; means for communicating, during the time window, with the user equipment by at least one of: providing signals for network measurements at the user equipment, and providing downlink data to the user equipment.

In an example, the means for communicating comprises: means for communicating with the user equipment by providing signals for network measurements at the user equipment using a first cell of a network node, and communicating with the user equipment by providing downlink data to the user equipment using a second cell of the network node, at the same time during the time window.

In an example, the configuration for the time window comprises an indication for the user equipment to associate the time window with a first receive element of a user equipment.

In an example, the apparatus comprises: means for providing, to the user equipment, information associating the configuration of a time window for network measurement with a network transmit beam index for downlink.

In an example, the apparatus comprises: means for providing, to the user equipment, information associating the activation of the time window for network measurement and a network transmit beam index for downlink.

In an example, the apparatus comprises: means for providing a configuration for a further time window to perform network measurements in, wherein the configuration for the further time window comprises an indication for the user equipment to associate the further time window with a second receive element of a user equipment; and means for communicating, during the further time window, with the user equipment by providing signals for network measurements at the user equipment.

In an example, one of: the apparatus is for a network node, the apparatus is comprised in the network node, and the apparatus is the network node.

According to an aspect, there is provided a method comprising: retrieving a configuration for a time window to perform network measurements in; associating the time window with a first receive element of a user equipment; and during the time window, performing a network measurement using the associated first receive element and receiving downlink data using a second receive element of the user equipment.

In an example, the downlink data is received without scheduling restrictions over the duration of the time window, such that downlink data is able to be received throughout the duration of the time window using the second receive element.

In an example, the method comprises: receiving, from a network node, information associating the configuration of a time window for network measurement with a network transmit beam index for downlink.

In an example, the method comprises: receiving, from a network node, information associating the activation of the time window for network measurement and a network transmit beam index for downlink.

In an example, the method comprises: receiving a configuration for a further time window to perform network measurements in; associating the further time window with the second receive element of the user equipment; and performing a network measurement during the further time window using the associated second receive element.

In an example, the time window comprises a plurality of time occasions.

In an example, the method comprises: assigning each of the plurality of time occasions of the time window for at least one of: the receiving of data, and the performing of network measurements; and performing at least one of: i) the reception data using at least one of: the first receive element, and the second receive element, and ii) network measurements using at least one of: the first receive element and the second receive element, during the time window, according to the assigning in each of the plurality of time occasions.

In an example, the associating comprises: associating the time window with: i) the first receive element of a user equipment, and ii) a second receive element of the user equipment.

In an example, the assigning comprises: assigning each of the plurality of time occasions of the time window for at least one of: the reception of data, and the performance of network measurements, using at least one of: the first receive element, and the second receive element of the user equipment.

In an example, for a time occasion of the plurality of time occasions, one of the first receive element and the second receive element is assigned for the reception of data, and the other of the first receive element and the second receive element is assigned for performing of network measurements.

In an example, for a time occasion of the plurality of time occasions, both the first receive element and the second receive element are assigned for one of: the reception of data, and the performing of network measurements.

In an example, the assignments for the reception of data, and the performing of network measurements, for both the first receive element and the second receive element, alternate between each time occasion in the time window.

In an example, for the time window, one of the first receive element and the second receive element is assigned for one of: the reception of data, and the performing of network measurements.

In an example, the time window comprises a synchronisation signal block-based measurement timing configuration, SMTC, window.

In an example, the retrieving comprises: receiving, from a network node, the configuration for the time window in a radio resource control reconfiguration message, wherein the configuration comprises information of the first receive element, and an indication that the first receive element is associated to network measurements, and wherein the configuration comprises information of the second receive element, and an indication that the second receive element is associated to downlink data reception.

In an example, the method is performed by the user equipment.

According to an aspect, there is provided a method comprising: providing, to a user equipment, a configuration for a time window to perform network measurements in; and communicating, during the time window, with the user equipment by at least one of: providing signals for network measurements at the user equipment, and providing downlink data to the user equipment.

In an example, the communicating comprises: communicating with the user equipment by providing signals for network measurements at the user equipment using a first cell of a network node, and communicating with the user equipment by providing downlink data to the user equipment using a second cell of the network node, at the same time during the time window.

In an example, the configuration for the time window comprises an indication for the user equipment to associate the time window with a first receive element of a user equipment.

In an example, the method comprises: providing, to the user equipment, information associating the configuration of a time window for network measurement with a network transmit beam index for downlink.

In an example, the method comprises: providing, to the user equipment, information associating the activation of the time window for network measurement and a network transmit beam index for downlink.

In an example, the method comprises: providing a configuration for a further time window to perform network measurements in, wherein the configuration for the further time window comprises an indication for the user equipment to associate the further time window with a second receive element of a user equipment; and communicating, during the further time window, with the user equipment by providing signals for network measurements at the user equipment.

In an example, the method is performed by the network node.

According to an aspect, there is provided an apparatus comprising: at least one processor, and at least one memory storing instructions that, when executed by the one or more processors, cause the apparatus to perform: retrieving a configuration for a time window to perform network measurements in; associating the time window with a first receive element of a user equipment; and during the time window, performing a network measurement using the associated first receive element and receiving downlink data using a second receive element of the user equipment.

In an example, the downlink data is received without scheduling restrictions over the duration of the time window, such that downlink data is able to be received throughout the duration of the time window using the second receive element.

In an example, the apparatus is caused to perform: receiving, from a network node, information associating the configuration of a time window for network measurement with a network transmit beam index for downlink.

In an example, the apparatus is caused to perform: receiving, from a network node, information associating the activation of the time window for network measurement and a network transmit beam index for downlink.

In an example, the apparatus is caused to perform: receiving a configuration for a further time window to perform network measurements in; associating the further time window with the second receive element of the user equipment; and performing a network measurement during the further time window using the associated second receive element.

In an example, the time window comprises a plurality of time occasions.

In an example, the apparatus is caused to perform: assigning each of the plurality of time occasions of the time window for at least one of: the receiving of data, and the performing of network measurements; and performing at least one of: i) the reception data using at least one of: the first receive element, and the second receive element, and ii) network measurements using at least one of: the first receive element and the second receive element, during the time window, according to the assigning in each of the plurality of time occasions.

In an example, the associating comprises: associating the time window with: i) the first receive element of a user equipment, and ii) a second receive element of the user equipment.

In an example, the assigning comprises: assigning each of the plurality of time occasions of the time window for at least one of: the reception of data, and the performance of network measurements, using at least one of: the first receive element, and the second receive element of the user equipment.

In an example, for a time occasion of the plurality of time occasions, one of the first receive element and the second receive element is assigned for the reception of data, and the other of the first receive element and the second receive element is assigned for performing of network measurements.

In an example, for a time occasion of the plurality of time occasions, both the first receive element and the second receive element are assigned for one of: the reception of data, and the performing of network measurements.

In an example, the assignments for the reception of data, and the performing of network measurements, for both the first receive element and the second receive element, alternate between each time occasion in the time window.

In an example, for the time window, one of the first receive element and the second receive element is assigned for one of: the reception of data, and the performing of network measurements.

In an example, the time window comprises a synchronisation signal block-based measurement timing configuration, SMTC, window.

In an example, the retrieving comprises: receiving, from a network node, the configuration for the time window in a radio resource control reconfiguration message, wherein the configuration comprises information of the first receive element, and an indication that the first receive element is associated to network measurements, and wherein the configuration comprises information of the second receive element, and an indication that the second receive element is associated to downlink data reception.

In an example, one of: the apparatus is for the user equipment, the apparatus is comprised in the user equipment, and the apparatus is the user equipment.

According to an aspect, there is provided an apparatus comprising: at least one processor, and at least one memory storing instructions that, when executed by the one or more processors, cause the apparatus to perform: providing, to a user equipment, a configuration for a time window to perform network measurements in, and communicating, during the time window, with the user equipment by at least one of: providing signals for network measurements at the user equipment, and providing downlink data to the user equipment.

In an example, the communicating comprises: communicating with the user equipment by providing signals for network measurements at the user equipment using a first cell of a network node, and communicating with the user equipment by providing downlink data to the user equipment using a second cell of the network node, at the same time during the time window.

In an example, the configuration for the time window comprises an indication for the user equipment to associate the time window with a first receive element of a user equipment.

In an example, the apparatus is caused to perform: providing, to the user equipment, information associating the configuration of a time window for network measurement with a network transmit beam index for downlink.

In an example, the apparatus is caused to perform: providing, to the user equipment, information associating the activation of the time window for network measurement and a network transmit beam index for downlink.

In an example, the apparatus is caused to perform: providing a configuration for a further time window to perform network measurements in, wherein the configuration for the further time window comprises an indication for the user equipment to associate the further time window with a second receive element of a user equipment; and communicating, during the further time window, with the user equipment by providing signals for network measurements at the user equipment.

In an example, one of: the apparatus is for a network node, the apparatus is comprised in the network node, and the apparatus is the network node.

According to an aspect, there is provided a computer program comprising instructions, which when executed by an apparatus, cause the apparatus to perform at least the following: retrieving a configuration for a time window to perform network measurements in; associating the time window with a first receive element of a user equipment; and during the time window, performing a network measurement using the associated first receive element and receiving downlink data using a second receive element of the user equipment.

According to an aspect, there is provided a computer program comprising instructions, which when executed by an apparatus, cause the apparatus to perform at least the following: providing, to a user equipment, a configuration for a time window to perform network measurements in; and communicating, during the time window, with the user equipment by at least one of: providing signals for network measurements at the user equipment, and providing downlink data to the user equipment.

A non-transitory computer readable medium comprising program instructions, that, when executed by an apparatus, cause the apparatus to perform at least the following: retrieving a configuration for a time window to perform network measurements in; associating the time window with a first receive element of a user equipment; and during the time window, performing a network measurement using the associated first receive element and receiving downlink data using a second receive element of the user equipment.

A non-transitory computer readable medium comprising program instructions, that, when executed by an apparatus, cause the apparatus to perform at least the following: providing, to a user equipment, a configuration for a time window to perform network measurements in; and communicating, during the time window, with the user equipment by at least one of: providing signals for network measurements at the user equipment, and providing downlink data to the user equipment.

A computer program comprising instructions stored thereon may cause the performing of the methods as described herein.

A computer program comprising instructions, which when executed by an apparatus, may cause the apparatus to perform the methods as described herein.

A computer product stored on a medium may cause an apparatus to perform the methods as described herein.

A non-transitory computer readable medium comprising program instructions, that, when executed by an apparatus, cause the apparatus to perform the methods as described herein.

An electronic device may comprise apparatus as described herein.

In the above, various aspects have been described. It should be appreciated that further aspects may be provided by the combination of any two or more of the various aspects described above.

Various other aspects and further embodiments are also described in the following detailed description and in the attached claims.

According to some aspects, there is provided the subject matter of the independent claims. Some further aspects are defined in the dependent claims. The embodiments that do not fall under the scope of the claims are to be interpreted as examples useful for understanding the disclosure.

### LIST OF ABBREVIATIONS

AF: Application Function
AMF: Access Management Function
AN: Access Network
BS: Base Station
CN: Core Network
DL: Downlink
eNB: eNodeB
FR2: Frequency Range 2
gNB: gNodeB
IIoT: Industrial Internet of Things
LTE: Long Term Evolution
NEF: Network Exposure Function
NG-RAN: Next Generation Radio Access Network
NF: Network Function
NR: New Radio
NRF: Network Repository Function
NW: Network
MIMO: Multiple-Input Multiple-Out
MS: Mobile Station
PCF Policy Control Function
PDSCH: Physical Downlink Shared Channel
PLMN: Public Land Mobile Network
RAN: Radio Access Network
RF: Radio Frequency
RRC: Radio Resource Control
RRM: Radio Resource Management
Rx: Receive
SCS: Subcarrier Spacing
SMF: Session Management Function
SMTC: SSB-based RRM measurement timing configuration
SSB: Synchronisation Signal Block
TCI: Transmission Configuration Information
TRP: Transmission Reception Point
UE: User Equipment
UDR: Unified Data Repository
UDM: Unified Data Management
UL: Uplink
UPF: User Plane Function
3GPP: 3^{rd} Generation Partnership Project
5G: 5^{th} Generation
5GC: 5G Core network
5G-AN: 5G Radio Access Network
5GS: 5G System

### DESCRIPTION OF FIGURES

Embodiments will now be described, by way of example only, with reference to the accompanying Figures in which:

FIG. 1 shows a schematic representation of a 5G system;

FIG. 2 shows a schematic representation of a control apparatus;

FIG. 3 shows a schematic representation of a terminal;

FIG. 4 shows a schematic representation of a user equipment with a single receive chain, and an example operation performed by the user equipment;

FIG. 5 shows a schematic representation of a user equipment with two receive chains;

FIG. 6a shows a schematic representation of a user equipment architecture with two receive chains per antenna panel;

FIG. 6b shows a schematic representation of a user equipment architecture with four receive chains per antenna panel;

FIG. 7 shows an example graphical representation of narrow and rough beam patterns;

FIG. 8 shows a schematic representation of scheduling restrictions;

FIG. 9a shows a schematic representation of a communication system whereby a user equipment is able to receive two downlink streams concurrently;

FIG. 9b shows a schematic representation of the communication system whereby the user equipment is able to receive a downlink stream and perform measurements concurrently;

FIG. 9c shows another schematic representation of the communication system whereby the user equipment is able to receive a downlink stream and perform measurements concurrently;

FIG. 10 shows a schematic representation of an association between SMTC configurations and transmission configuration information states;

FIG. 11 shows an example signalling diagram between a serving cell and a user equipment with multiple receive chains;

FIG. 12 shows a schematic representation of the simultaneous data reception and measurement performance by a user equipment with multiple receive chains;

FIG. 13 shows an example method flow diagram performed by a user equipment;

FIG. 14 shows another example method flow diagram performed by a network node; and

FIG. 15 shows a schematic representation of a non-volatile memory medium storing instructions which when executed by a processor allow a processor to perform one or more of the steps of the method of FIGS. 13 and 14.

### DETAILED DESCRIPTION

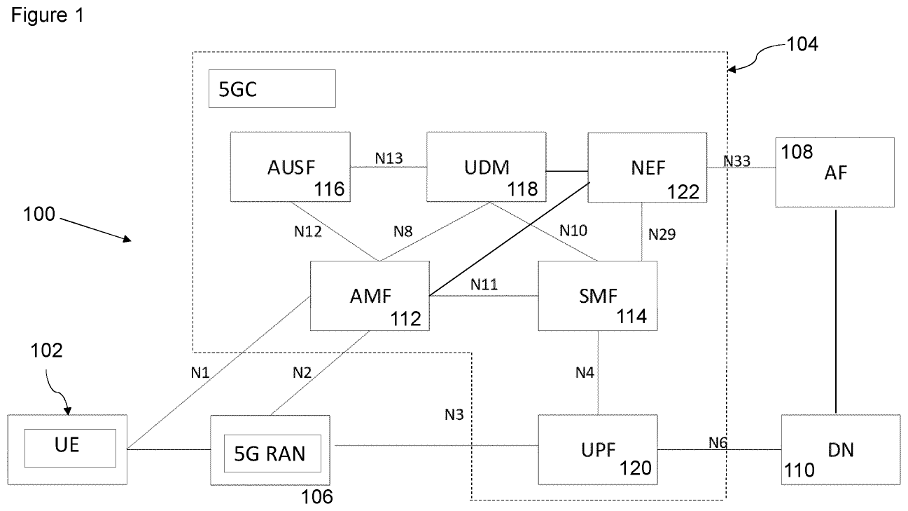

Before explaining in detail some examples of the present disclosure, certain general principles of a wireless communication system and mobile communication devices are briefly explained with reference to FIGS. 1 to 3 to assist in understanding the technology underlying the described examples.

In a wireless communication system 100, such as that shown in FIG. 1, mobile communication devices/terminals or user apparatuses, and/or user equipments (UE), and/or machine-type communication devices 102 are provided wireless access via at least one base station (not shown) or similar wireless transmitting and/or receiving node or point. A communication device is provided with an appropriate signal receiving and transmitting apparatus for enabling communications, for example enabling access to a communication network or communications directly with other devices. The communication device may access a carrier provided by a station or access point, and transmit and/or receive communications on the carrier.

In the following certain examples are explained with reference to mobile communication devices capable of communication via a wireless cellular system and mobile communication systems serving such mobile communication devices. Before explaining in detail the examples of the disclosure, certain general principles of a wireless communication system, access systems thereof, and mobile communication devices are briefly explained with reference to FIGS. 1, 2 and 3 to assist in understanding the technology underlying the described examples.

FIG. 1 shows a schematic representation of a 5G system (5GS) 100. The 5GS may comprise a device 102 such as user equipment or terminal, a 5G radio access network (5G-RAN) 106, a 5G core network (5GC) 104, one or more network functions (NF), one or more application function (AF) 108 and one or more data networks (DN) 110.

The 5G-RAN 106 may comprise one or more gNodeB (gNB) distributed unit functions connected to one or more gNodeB (gNB) centralized unit functions.

The 5GC 104 may comprise an access management function (AMF) 112, a session management function (SMF) 114, an authentication server function (AUSF) 116, a user data management (UDM) 118, a user plane function (UPF) 120, a network exposure function (NEF) 122 and/or other NFs. Some of the examples as shown below may be applicable to 3GPP 5G standards. However, some examples may also be applicable to 6G, 4G, 3G and other 3GPP standards.

In a communication system, such as that shown in FIG. 1, mobile communication devices/terminals or user apparatuses, and/or user equipments (UE), and/or machine-type communication devices are provided with wireless access via at least one base station or similar wireless transmitting and/or receiving node or point. The terminal is provided with an appropriate signal receiving and transmitting apparatus for enabling communications, for example enabling access to a communication network or communications directly with other devices. The communication device may access a carrier provided by a base station or access point, and transmit and/or receive communications on the carrier.

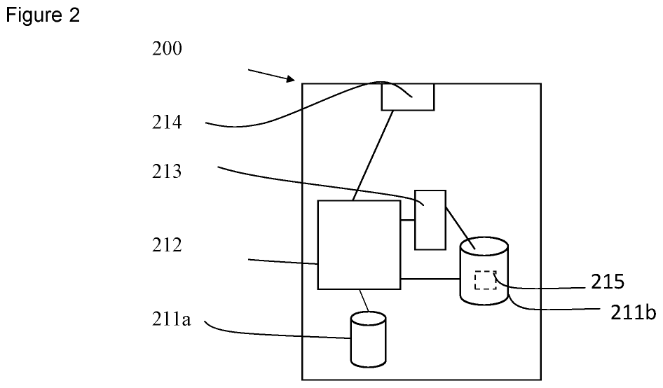

FIG. 2 illustrates an example of a control apparatus 200 for controlling a function of the 5G-RAN or the 5GC as illustrated on FIG. 1. The control apparatus may comprise at least one random access memory (RAM) 211a, at least one read only memory (ROM) 211b, at least one processor 212, 213 and an input/output interface 214. The at least one processor 212, 213 may be coupled to the RAM 211a and the ROM 211b. The at least one processor 212, 213 may be configured to execute an appropriate software code 215. The software code 215 may for example allow to perform one or more steps to perform one or more of the present aspects. The software code 215 may be stored in the ROM 211b. The control apparatus 200 may be interconnected with another control apparatus 200 controlling another function of the 5G-AN or the 5GC. In some examples, each function of the 5G-AN or the 5GC comprises a control apparatus 200. In alternative examples, two or more functions of the 5G-AN or the 5GC may share a control apparatus.

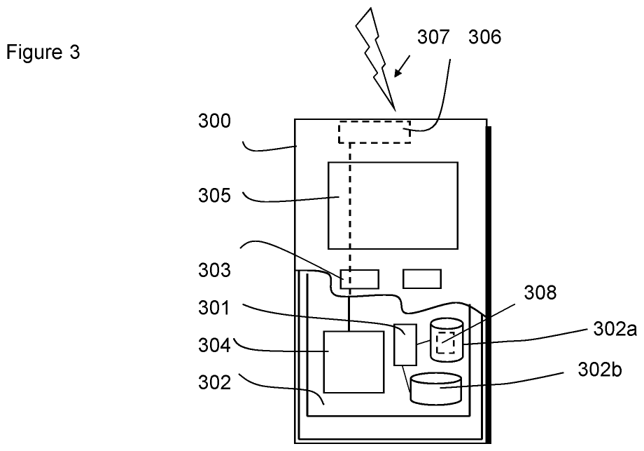

FIG. 3 illustrates an example of a terminal 300, such as the terminal illustrated on FIG. 1. The terminal 300 may be provided by any device capable of sending and receiving radio signals. Non-limiting examples comprise a user equipment, a mobile station (MS) or mobile device such as a mobile phone or what is known as a ‘smart phone’, a computer provided with a wireless interface card or other wireless interface facility (e.g., USB dongle), a personal data assistant (PDA) or a tablet provided with wireless communication capabilities, a machine-type communications (MTC) device, a Cellular Internet of things (CIoT) device or any combinations of these or the like. The terminal 300 may provide, for example, communication of data for carrying communications. The communications may be one or more of voice, electronic mail (email), text message, multimedia, data, machine data and so on.

The terminal 300 may receive signals over an air or radio interface 307 via appropriate apparatus for receiving and may transmit signals via appropriate apparatus for transmitting radio signals. In FIG. 3, a transceiver apparatus is designated schematically by block 306. The transceiver apparatus 306 may be provided for example by means of a radio part and associated antenna arrangement. The antenna arrangement may be arranged internally or externally to the mobile device. The antenna arrangement may comprise multiple antenna panels. Each antenna panel may be associated with a receive chain for processing. Antennas for millimetre waves may be a single element or an antenna array. The array may be steered with phase shifters.

The terminal 300 may be provided with at least one processor 301, at least one memory ROM 302a, at least one RAM 302b and other possible components 303 for use in software and hardware aided execution of tasks it is designed to perform, including control of access to and communications with access systems and other communication devices. The at least one processor 301 is coupled to the RAM 302b and the ROM 302a. The at least one processor 301 may be configured to execute an appropriate software code 308. The software code 308 may for example allow to perform one or more of the present aspects. The software code 308 may be stored in the ROM 302a.

The processor, storage and other relevant control apparatus may be provided on an appropriate circuit board and/or in chipsets. This feature is denoted by reference 304. The device may optionally have a user interface such as keypad 305, touch sensitive screen or pad, combinations thereof or the like. Optionally one or more of a display, a speaker and a microphone may be provided depending on the type of the device.

One or more of the following examples may be applicable to 3GPP 5G communications. These examples may also be applicable to 5G advanced (5G-A) as well as future and older 3GPP standards including 4G, LTE, 3G, etc.

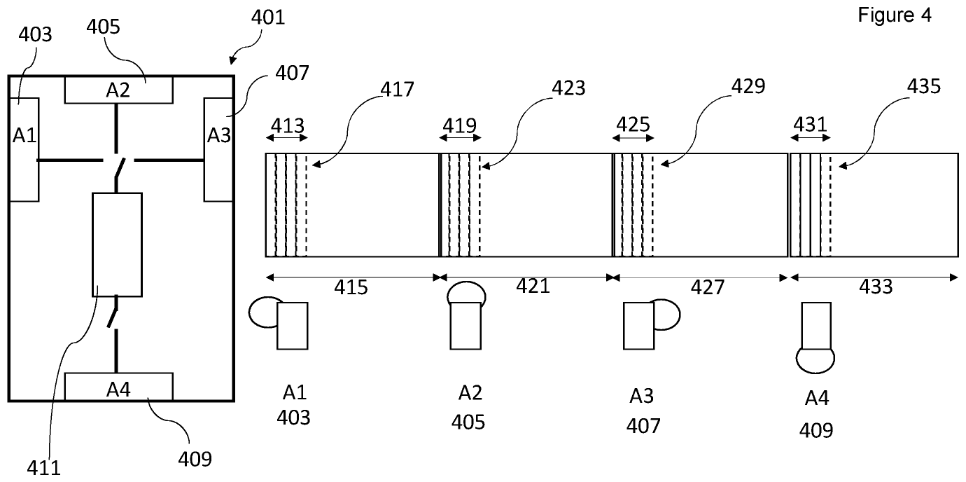

5G frequency range 2 (FR2) comprises operational frequencies that have been allocated to 5G in the millimetre wave (mmWave) region (i.e. above 24 GHz). FR2 antenna arrays on user equipments (UEs) may be assumed to be directive. Due to this, in order to achieve good performance, UEs may comprise a plurality of antenna panels embedded. However, a number of antenna panels and a number of receive (Rx) chains comprised within the UE do not necessarily need to have a 1-to-1 mapping. As such, 3GPP Rel-17 FR2 RAN4 requirements are assuming a single Rx chain UE, which means that Rel-17 UEs (and earlier) can fulfil the RAN4 requirements assuming that a single Rx chain is activated. Hence, a UE may have a single active FR2 panel/Rx chain at the time. This behaviour may have the benefit for UE implementation in making the implementation simpler, in particular for early implementations while not limiting the UE implementation. However, this behaviour has the drawback on, for example, neighbour cell measurements since a single Rx reception assumption means the UE has to sweep its reception over antenna panels assuming one Rx chain at the time. Hence, the UE would sweep in order to get a full picture of its environment, with spherical coverage, which leads to a time delay (sweep delay). This is illustrated in FIG. 4. Here, it is shown that a single Rx chain, four antenna panel, UE requires 4 consecutive Rx sweep for a single sample full spherical measurement acquisition. Then, additionally, 3-5 samples per Rx sweep direction are assumed to be needed for each Rx spatial setting for L1 and/or L3 measurements to ensure the UE cell detection and/or measurement accuracy.

FIG. 4 shows a schematic representation of a user equipment (UE) with a single receive chain, and an example operation performed by the UE.

There is provided a UE 401. The UE 401 comprises a first antenna panel, A1, which is labelled 403, a second antenna panel, A2, which is labelled 405, a third antenna panel, A3, which is labelled 407, and a fourth antenna panel, A4, which is labelled 409.

The UE 401 comprises a receive element 411 (Rx element). The receive element may also be referred to as an Rx chain 411. The Rx chain 411 is connectable to any of the four antenna panels 403, 405, 407, 409.

FIG. 4 also shows a sample operation of the UE 401, whereby the UE 401 operates each of the four antenna panels 403, 405, 407, 409 individually.

The operation shows a first time window 413, and a first time period 415. During the first time window 413 the UE 401 is performing a burst of measurements 417 using beams from the first antenna panel 403. For example, the beams are rough beams.

The operation shows a second time window 419, and a second time period 421. During the second time window 419 the UE 401 is performing a burst of measurements 423 using beams from the second antenna panel 405. For example, the beams are rough beams.

The operation shows a third time window 425, and a third time period 427. During the third time window 425 the UE 401 is performing a burst of measurements 429 using beams from the third antenna panel 407. For example, the beams are rough beams.

The operation shows a fourth time window 431, and a fourth time period 433. During the fourth time window 431 the UE 401 is performing a burst of measurements 435 using beams from the fourth antenna panel 409. For example, the beams are rough beams.

For example, when each time window is 5 milliseconds (ms), and each time period is 20 ms, it will take the UE 401 80 ms in order to perform spherical measurements, around the whole UE 401.

In this example, the UE uses the synchronisation signal block (SSB) burst for cell detection and measurements. In this example of FIG. 4, four SSB bursts are used for enabling reception of each burst in a spherical coverage. In this example, each SSB burst is transmitted by the gNB to the UE once per 20 ms. In other examples, the period may be higher or lower than 20 ms. A baseline assumption with 1 Rx chain active at a time means that a UE can sample in a single direction once per SSB burst.

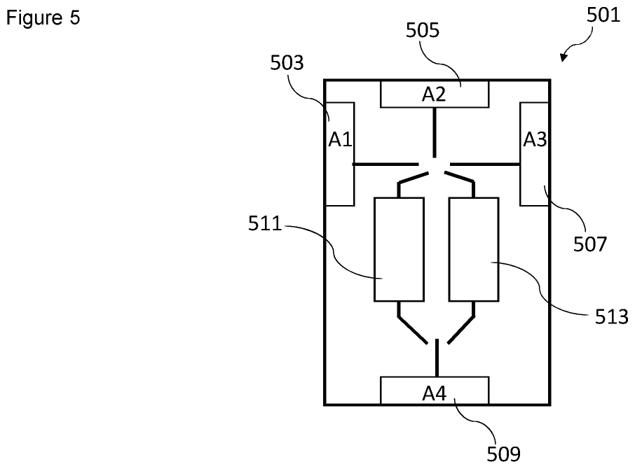

FIG. 5 shows a schematic representation of a UE with two receive chains.

There is provided a UE 501. The UE 501 comprises a first antenna panel, A1, which is labelled 503, a second antenna panel, A2, which is labelled 505, a third antenna panel, A3, which is labelled 507, and a fourth antenna panel, A4, which is labelled 509. The UE 501 comprises a first Rx element 511 and a second Rx element 513. The first Rx element may be referred to as a first Rx chain 511 and the second Rx element may be referred to as a second Rx chain 513. Each of the Rx chains 511 and 513 may be connectable to any of the four antenna panels 503, 505, 507, 509. The first and/or second Rx elements/chains 511, 513 may comprise circuitry configured to receive signals from one or more of the antenna panels 503, 505, 507, 509, and decode those signals.

This UE 501 architecture has advantages to UE and system level performance in, for example, measurement related latencies. In this example of FIG. 5, the four antenna panels 503, 505, 507, 509 are assumed to be implemented in the UE 501, which are placed in a way to improve spherical coverage, and the Rx chains 511, 513 can be used simultaneously. The two Rx chains 511, 513 may be active simultaneously among the four antenna panels 503, 505, 507, 509, which could include any combination of two antenna panels 503, 505, 507, 509 that may be activated simultaneously. In some examples, more than, or less than four antenna panels are provided in the UE 501.

With the UE 501 of FIG. 5, the UE 501 is able to perform measurements including, for example, radio resource management (RRM) measurements using more than one Rx chain at the same time. In other implementations, the UE 501 may receive and perform RRM measurements using one Rx chain 511 while receiving data using other Rx chain 513.

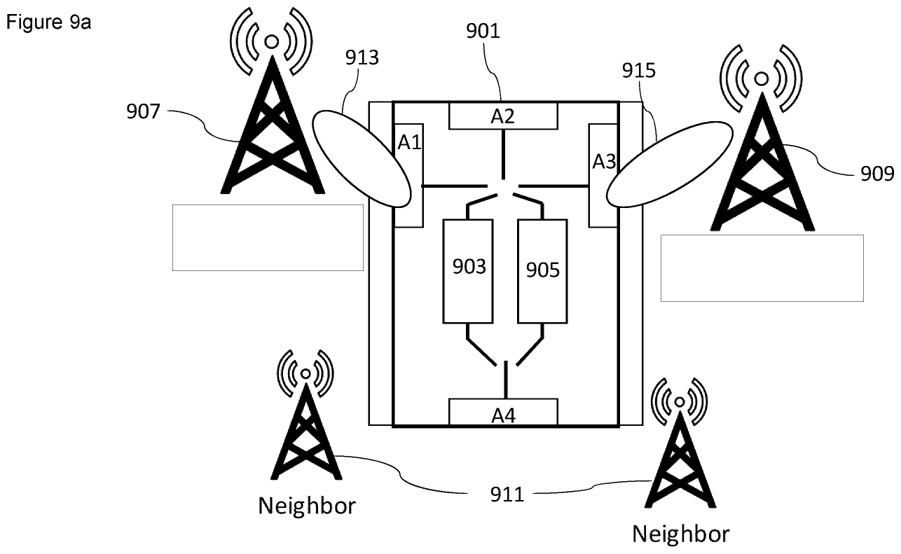

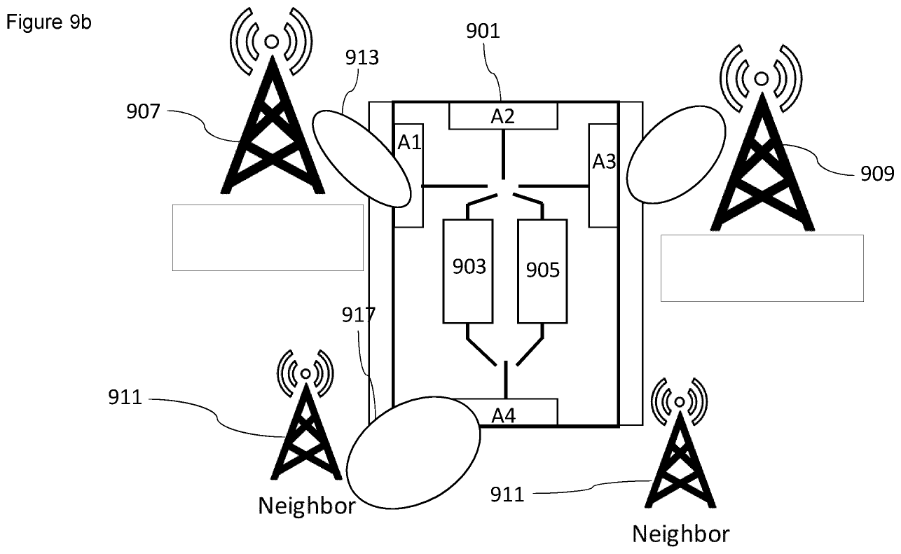

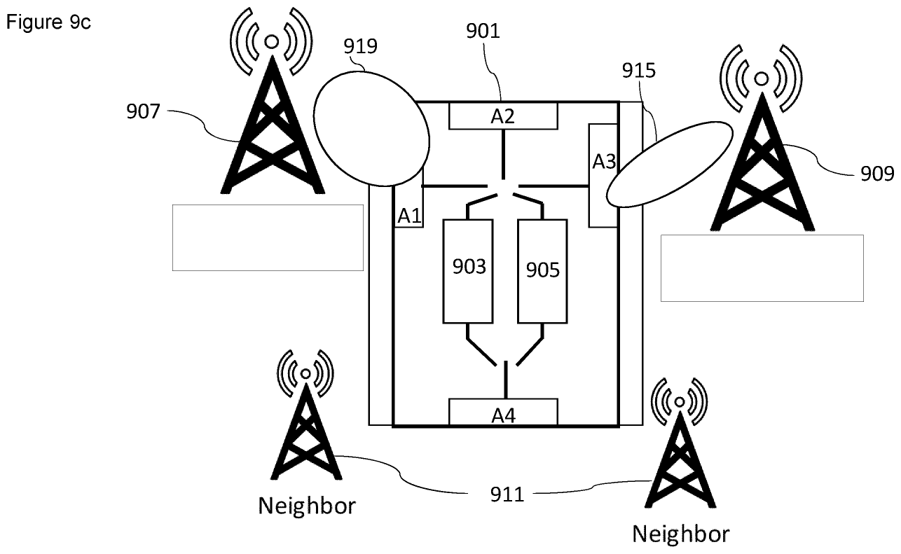

In a downlink (DL) data reception scenario, a multi Rx UE is expected to be able to receive on two Rx data chains. The data being received may be from different transmission sources. Examples of transmission sources include transmission reception points (TRPs), remote radio heads (RRHs), cells (wherein cells may be provided by a same or different gNBs). This is illustrated in FIG. 9a, whereby a UE uses two Rx chains for receiving data using two different Rx chains from two different TRPs. In this example, the different TRPs are located at different locations. In this scenario of FIG. 9a, the UE may receive four-layer DL MIMO, since in FR2, each antenna panel may use cross-polarized antennas in order to achieve two layers. Hence, when combining two antenna panels, four layers can be achieved. This will be described in more detail below.

Even though four-layer DL MIMO may be achieved with multiple Rx chains in the UE in some examples, the UE may not be able to receive data in four layers while performing RRM measurements simultaneously. Typically, in FR2, layer 3 (L3) RRM measurements are performed with different spatial Rx setting in the UE than are used for data reception, data transmission, and L1 measurements. In some common implementations, a broad/wide beam (spatial UE Rx setting) is associated to each UE panel for L3 measurements and, while no beam refinement is applied, Rx sweeping is used when conducting such measurements.

It has been identified that with a single Rx chain, a UE cannot perform DL demodulation and RRM measurements tasks simultaneously. However, with two Rx chains, each of the two Rx chains may be performing different tasks independently. Hence, some UEs may be able to receive data with one active Rx chain and perform measurements with the other Rx chain. Other UE implementations may be able to measure using two Rx chains simultaneously. While in some implementation, a UE would not be able to perform measurements and data reception simultaneously.

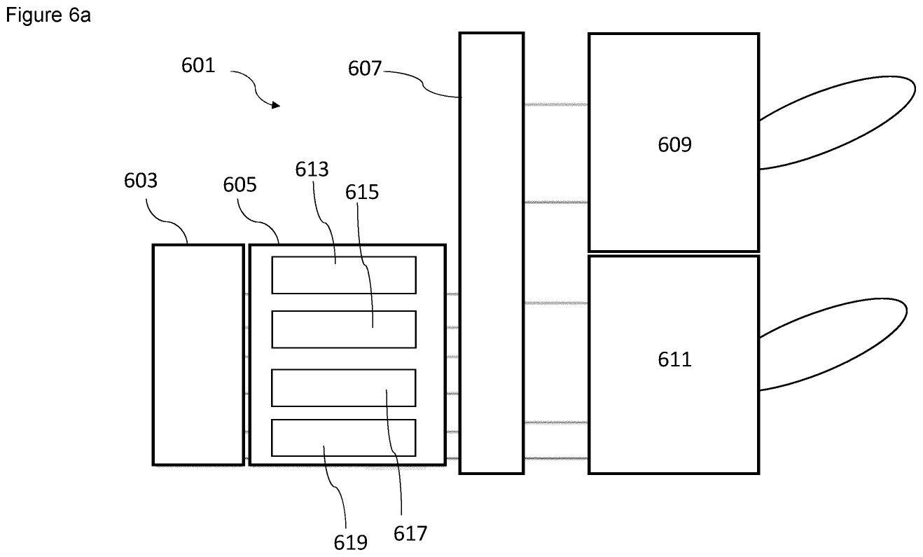

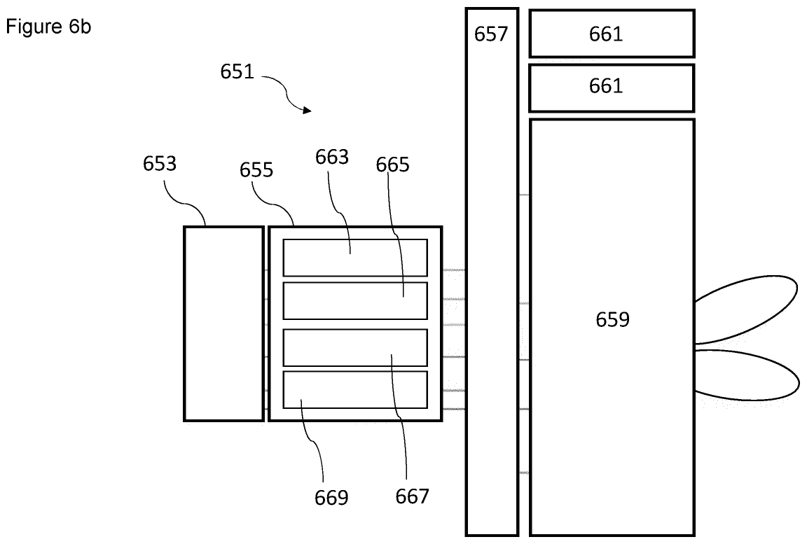

FIGS. 6a and 6b show two possible UE panel architectures that may be considered. It should be understood that these architectures are shown as examples only.

FIG. 6a shows a schematic representation of a UE architecture with two receive chains per antenna panel.

The UE architecture 601 comprises baseband circuitry 603 which is connected to transmit/receive circuitry 605. The transmit/receive circuitry 605 is connected to a multiplexer 607. The multiplexer 607 is connected to a first antenna panel 609, and a second antenna panel 611. The first 609 and second antenna panels 611 are configured to transmit and/or receive data, measurements, etc.

The transmit/receive circuitry 605 comprises four Rx chains 613, 615, 617, 619. Two of the Rx chains 613, 615 are associated with the first antenna panel 609. The other two Rx chains 617, 619 are associated with the second antenna panel 611. In this way, two RX chains are provided for each antenna panel.

FIG. 6b shows a schematic representation of a UE architecture with four receive chains per antenna panel.

The UE architecture 651 comprises baseband circuitry 653 which is connected to transmit/receive circuitry 655. The transmit/receive circuitry 655 is connected to a multiplexer 657. The multiplexer 657 is connected to a first antenna panel 659 Further antenna panels 661 are also shown. In this example, there are a further two antenna panels. In other examples there may be more or less than these further antenna panels. The first 659 and further antenna panels 661 are configured to transmit and/or receive data, measurements, etc.

The transmit/receive circuitry 655 comprises four Rx chains 653, 655, 657, 659. All of the four Rx chains 653, 655, 657, 659 are associated with the first antenna panel 659. In this way, four RX chains are provided for the same antenna panel. The four Rx chains 653, 655, 657, 659 may also be associated with the further antenna panels 611 (not shown).

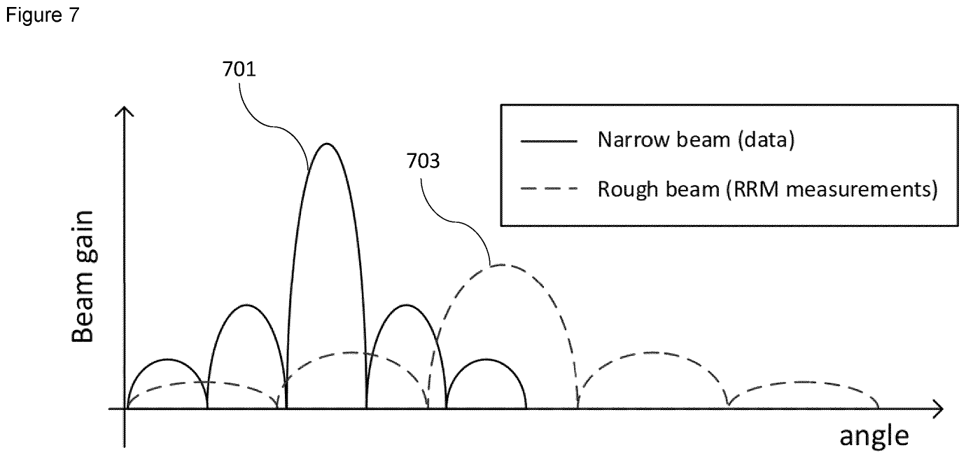

It has been identified that some UE architectures may not be able to use two Rx chains from the same antenna panel, which indicates that a minimum angle separation should exist between the beams used for each of the Rx chains. This minimum separation may have some impacts as to which beams the UE can simultaneously use for data and RRM measurements. This may mean that narrow beams, used for data, should be turned off whenever the UE has to perform RRM measurements on a similar direction than that of the narrow data beam. This is illustrated in FIG. 7.

FIG. 7 shows an example graphical representation of narrow and rough beam patterns.

There is shown a graph with ‘angle’ provided on the x-axis, and ‘beam gain’ provided on the y-axis. A narrow beam 701 beam-pattern is shown graphically, with a solid line. The narrow beam may be used for data receptions and/or transmissions. A rough beam beam-pattern 703 is shown graphically, with a dashed line. The rough beam may be used for network measurements, such as for example, RRM measurements. The beam pattern for the rough beam 703 has a larger range of beam angle compared to the narrow beam 701. However, the beam pattern for the rough beam 703 has a smaller peak beam gain compared to the narrow beam 701. Since the rough beam 703 typically uses less antenna elements, it has smaller beamforming gain in comparison to the narrow beam 701 in order to have a wider beam width and detect neighbour cells.

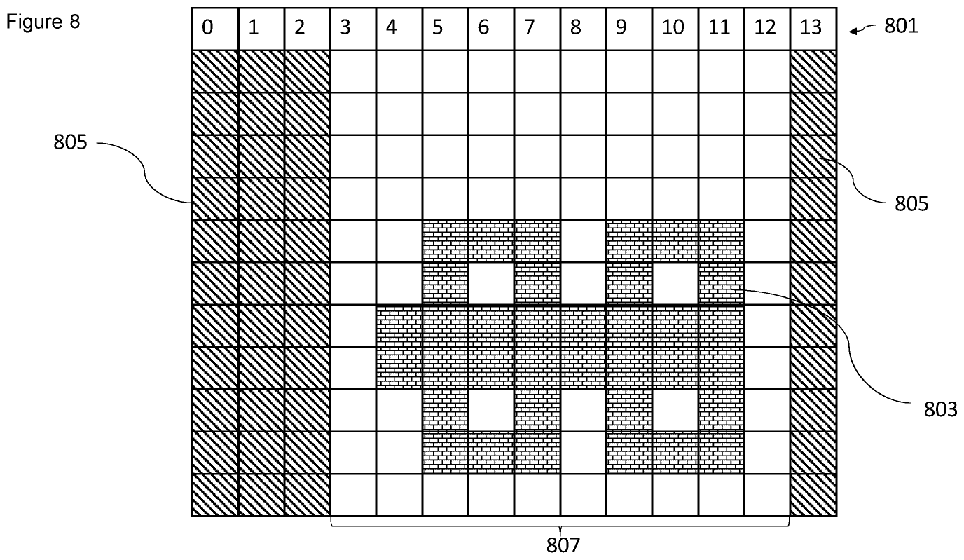

As part of 3GPP Rel-15 to Rel-17 RRM requirements, scheduling restrictions apply when a UE is performing RRM measurements. This is illustrated in FIG. 8.

FIG. 8 shows a schematic representation of scheduling restrictions. FIG. 8 is shown when considering a 120 kHz subcarrier spacing (SCS) numerology (i.e. synchronisation signal block (SSB) and physical downlink shared channel (PDSCH) using 120 kHz SCS).

There are provided 14 orthogonal frequency division multiplex (OFDM) symbols 801, which are individually numbered. Within the 14 OFDM symbols 801 there are shown SSB resources 803. The SSB resources 803 are shown as brickwork patterned blocks. Symbols labelled 0, 1, 2 and 13 are resources that are available for data 805. The resources available for data 805 are shown as diagonally hatched blocks. Symbols labelled 3 to 12 are resources that have scheduling restrictions 807 (i.e. due to the UE monitoring the SSB resources).

With these restrictions 807, one symbol before and one symbol after the SSB resource symbols are not available for the UE to be scheduled (for data). This may be due to, for example, the changing of spatial filter parameters at the UE while doing RRM measurements in other directions.

Due to the scheduling restrictions, 4 symbols out of the total 14 symbols 801 are available for the scheduling of data. If it is considered that the SSB-based RRM measurement timing configuration (SMTC) window may be, for example, 5 ms, this means that if all of the SSB resource 803 positions are used inside the SMTC window, only 28% of the resources (in time) are available during that SMTC window.

3GPP specifications have introduced SMTC windows to be used to notify UEs and other devices regarding the measurement periodicity and timings of SSBs that the UEs can use for performing measurements.

In some situations, a SMTC may be re-used for several UEs in the network, meaning that those UEs will be restricted to the same symbols. This leaves a comparatively small amount of time resources for the network to schedule UEs. As a result, this scheduling restriction may lead to large latency delays in the network, particularly when considering a busy network.

In situations when RRM measurements are to be performed, in some examples, a UE may change the Rx settings/configuration to perform RRM measurements. For a multi Rx chain UE, the UE may switch at least one of its Rx chains from DL data reception mode to RRM measurement mode, when performing measurements. This situation is illustrated in FIGS. 9a to 9c.

FIG. 9a shows a schematic representation of a communication system whereby a UE is able to receive two downlink streams concurrently.

The UE 901 comprises four antenna panels labelled A1 to A4. The UE 901 comprises two Rx chains 903, 905. There is also a first serving node 907, and a second serving node 909. The first 907 and second serving nodes 909 may be transmission sources. Examples of transmission sources include TRPs, RRHs, cells (wherein cells may be provided by a same or different gNBs). There are also two neighbour cells/nodes 911.

Antenna panel A1 is receiving a first DL data reception 913 from the first serving node 907. Antenna panel A3 is receiving a second DL data reception 915 from the second serving node 909. The DL data receptions occur concurrently (i.e. at the same time) as the UE 901 has two separate RX chains 903, 905. One of the Rx chains 903 decodes the DL data reception from the first serving node TRP 907, while the other of the RX chains 905 decodes the DL data reception from the second serving node 909.

In this configuration example, the UE 901 has two narrow beams dedicated for data reception. That may be achieved by configuring two active transmission configuration information (TCI) states, which may be connecting the UE 901 to the different non-collocated serving nodes 907, 909.

A TCI state may also be referred to as a network transmit beam index for downlink.

FIG. 9b shows a schematic representation of the communication system whereby the UE 901 is able to receive a downlink stream and perform measurements concurrently.

FIG. 9b shows the operation of the UE 901 changing, when compared to FIG. 9a. Antenna panel A1 continues to receive a first DL data reception 913 from the first serving node 907. The operation changes in that antenna panel A4 is used to perform measurements 917 on the neighbour cell 911. For example, using panel A4 and the receive chain 905. In that case, the data stream 915 from FIG. 9a is interrupted (due to the performing of measurements) while the UE is performing such measurements using panel A4. The measurements may be referred to as network measurements. For example, the network measurements may be RRM measurements, or any other suitable measurements. In some examples, performing network measurements may comprise receiving reference signals or the like. The RRM measurements may include sweeping measurements in different directions and/or with different spatial filters. The DL data reception and the network measurements occur concurrently (i.e. at the same time) using the different Rx panels or spatial settings as the UE 901 has the two separate RX chains 903, 905.

FIG. 9c shows another schematic representation of the communication system whereby the user equipment is able to receive a downlink stream and perform measurements concurrently. In this scenario, the UE is to perform measurements on the direction covered by the antenna panel A1. Due to this, the UE switches to a spatial Rx configuration on the antenna panel A1.

As seen in FIG. 9c, antenna panel A1 is used for performing measurements 919 on the first serving node 907. Data receptions from the first serving node 907 will therefore be interrupted while performing those measurements. Antenna panel A3 may continue to receive a DL data reception 915 from the second serving node 909. This is shown in FIG. 9c with a narrow beam from the second serving node 909 to antenna panel A3.

It has been identified that UEs comprising multiple Rx chains have problems with scheduling optimisations when the UE is performing measurements. This is because the UE is limited for data scheduling on one or more of its Rx chains while it is performing measurements.

In known systems, when a UE is performing RRM measurements, at least one symbol before, at least one symbol after, and for the symbols on which it is measuring (e.g., SSB symbols) there are scheduling restrictions, in order to allow the measurement to be performed. This means that the network cannot assume that the UE can receive or transmit any data during those symbols.

One or more of the following examples aims to address one or more of the problems identified above.

In examples, there is an apparatus with means for retrieving a configuration for a time window to perform network measurements in, and means for associating the time window with a receive chain of a user equipment. The apparatus also has means for performing a network measurement during the time window using the associated receive chain. In this way, if the apparatus were to be a UE, or comprised within a UE, with multiple Rx chains, one of the Rx chains is associated with the time window for measurements so that other Rx chains may receive DL data without suffering from the scheduling restrictions on certain symbols, as discussed above. This will be described in more detail below. In some examples, the multiple Rx chains from the UE are associated at the UE to a TCI state.

In some examples, there is a balancing of scheduling restrictions during RRM measurements when a UE that is capable of multiple Rx chain reception is used. In this way, the UE which may receive with more than one Rx chain simultaneously.

In some examples, UEs and base station (e.g. gNBs) exchange information to configure UEs for the association. The exchanged information may allow these entities to define when one or more Rx chains in UEs are being interrupted/having scheduling restrictions. The interruptions/scheduling restrictions may be due to UEs performing, for example, L3 RRM measurements.

In some examples, to ensure preservation of the UE power consumption, the mechanism of associating the time window with an Rx chain is applied when a UE has more than one Rx chain in active use.

In some examples, the mechanism of association may be realised at UEs without a signalling exchange with the network. In these cases, the configuration of the UEs may be specified with (pre-configured) UE behaviour.

The usage of the configured time window may be split (or shared) among Rx chains, in some examples. The time window may be a SMTC window in some examples. For example, a network may configure a UE with a measurement object for a given frequency which includes an SMTC per ssbFrequency with a given periodicity. ssbFrequency indicates the frequency of the synchronisation signal associated to a MeasObjectNR. The SMTC configuration comprises a plurality of the time occasions. Each time occasion may comprise an SSB burst. The time occasions may be, for example, one or more symbols or one or more slots. When the SMTC configuration is known/received at the UE, the UE may share SMTC time occasions between the Rx chains (of the UE).

For example, if a periodicity of twice the SMTC periodicity is configured by the network, the UE may perform simultaneous measurements on multiple directions at the same time using multiple receiver chains. The measurements with multiple Rx chains may be performed by increasing the SMTC period of multiple Rx UEs in comparison to single Rx UEs. An example would be that with a single Rx UE, there may be an SMTC of 40 ms, while for dual Rx UE there is an SMTC of 80 ms. These numbers are given as examples only. Alternatively, the STMC configuration may be offset for each receiver chain.

The splitting/sharing of the SMTC window may be implemented with a number of different configurations at the UE. If a SMTC window has a specified/predetermined number of measurements that should be made, then for UEs with multiple Rx chains, these measurements may be shared between the Rx chains. Four example options are shown below, each with an associated table:

For example, the SMTC sharing is such that when one Rx chain is used for performing network measurements, the other Rx chain will be available for data reception. This allows for data reception without scheduling restrictions on the Rx chain used for data reception. This is shown below in Table 1. Table 1 shows that Rx1 and Rx2 chains of a UE will be used for network measurements in an alternating manner, per time occasion of the SMTC window.

TABLE 1
Example configuration for SMTC sharing in an alternating manner.

| SMTC occ. # | | 0 | 1 | 2 | 3 | 4 | 5 | 6 | 7 | 8 | 9 | 10 | 11 |
|---|---|---|---|---|---|---|---|---|---|---|---|---|---|
| Configured SMTC | | x | x | x | x | x | x | x | x | x | x | x | x |
| Rx 1 (TCI1) | SMTC | x | | x | | x | | x | | x | | x | |
| Rx 2 (TCI2) | SMTC | | x | | x | | x | | x | | x | | x |

In this example, there are shown 12 time occasions of the SMTC window. Each of the time occasions is configured to be used for network measurements, as indicated by the ‘x’ in the second row. An ‘x’ included in the Rx1 row, or Rx2 row, indicates that the Rx chain is associated with the SMTC window used e.g., for measurements for that time occasion.

In this example, if TCI1 becomes no longer active, then TCI2 may use all the SMTC occasions as shown in the table 1.1 below. This may occur if, for example, TCI1 is to be used for scheduling data.

TABLE 1.1
Example configuration for SMTC when TCI1 is no longer active.

| SMTC # | | 0 | 1 | 2 | 3 | 4 | 5 | 6 | 7 | 8 | 9 | 10 | 11 |
|---|---|---|---|---|---|---|---|---|---|---|---|---|---|
| Configured SMTC | | x | x | x | x | x | x | x | x | x | x | x | x |
| Rx 1 (TCI1) | SMTC | — | — | — | — | — | — | — | — | — | — | — | — |
| Rx 2 (TCI2) | SMTC | x | x | x | x | x | x | x | x | x | x | x | x |

In another example, the network may choose to configure two SMTC windows. For example, one SMTC window per TCI, rather than sharing the occasions of a single SMTC window configuration. This case is shown in Table 2 below, with two active TCIs.

TABLE 1.2
Example configuration for SMTC with two SMTC windows.

| SMTC occ. # | | 0 | 1 | 2 | 3 | 4 | 5 | 6 | 7 | 8 | 9 | 10 | 11 |
|---|---|---|---|---|---|---|---|---|---|---|---|---|---|
| Configured SMTC_A | | x | | x | | x | | x | | x | | x | |
| Configured SMTC_B | | | x | | x | | x | | x | | x | | x |
| Rx 1(TCI1) | SMTC_A | x | | x | | x | | x | | x | | x | |
| Rx 2(TCI2) | SMTC_B | | x | | x | | x | | x | | x | | x |

In this example, if TCI2 becomes no longer in use, the network may de-activate the configured SMTC_B. This is shown in Table 2.1 below.TCI1 will then be indicated and SMTC_A is activated. At this point, TCI2 is not actively used for scheduling.TCI2 may be in the active TCI list, though it is not indicated by network for scheduling data.

TABLE 2.1
Example configuration for SMTC when configured SMTC_B is de-activated.

| SMTC occ. # | | 0 | 1 | 2 | 3 | 4 | 5 | 6 | 7 | 8 | 9 | 10 | 11 |
|---|---|---|---|---|---|---|---|---|---|---|---|---|---|
| Configured SMTC_A | | x | | x | | x | | x | | x | | x | |
| Configured SMTC_B | | | x | | x | | x | | x | | x | | x |
| Rx 1 (TCI1) | SMTC_A | x | | x | | x | | x | | x | | x | |
| Rx 2 (TCI2) | SMTC_B | | — | | — | | — | | — | | — | | — |

In another example, the same time occasions of the SMTC window are assigned for the two Rx chains. In this case, a longer SMTC periodicity may be used For example, a period that is twice as long as the SMTC period used if 1 Rx chain is used). An Rx chain may be considered to be associated with/or equivalent to a TCI state. In this way, a UE with two Rx chains may support simultaneous reception from two active or indicated TCI states. This is shown in Table 3 below. The association between TCI state (index) and UE panels and/or Rx chains may not be fixed. The association between TCI state (index) and UE panels and/or Rx chains may dynamically change.

TABLE 3
Another example configuration for SMTC sharing wherein
both Rx chains have the same configuration.

| SMTC occ. # | | 0 | 1 | 2 | 3 | 4 | 5 | 6 | 7 | 8 | 9 | 10 | 11 |
|---|---|---|---|---|---|---|---|---|---|---|---|---|---|
| Configured SMTC | | x | x | x | x | x | x | x | x | x | x | x | x |
| Rx 1 (TCI1) | SMTC | x | | x | | x | | x | | x | | x | |
| Rx 2 (TCI2) | SMTC | x | | x | | x | | x | | x | | x | |

The UE is able to perform RRM measurements using two Rx chains simultaneously. Therefore, the number of measurement occasions needed for acquiring the necessary measurement samples may be reduced due to the UE's capability of simultaneous measurements. In this example, both Rx chains (Rx1 and Rx2) are associated with SMTC occasions 0, 2, 4, 6, 8, 10. Both Rx chains will perform network measurements in these SMTC occasions. In the other SMTC occasions there will be data reception without any restrictions on UE side. In this way, all 12 measurements (or 12 sets of measurements) are performed.

In another example, the same time occasions of the SMTC window are assigned for both Rx chains, while the measurement delay is prioritised. This is shown in Table 4 below.

TABLE 4
Another example configuration for SMTC sharing wherein both Rx chains
have the same configuration, while measurement delay is prioritised.

| SMTC occ. # | | 0 | 1 | 2 | 3 | 4 | 5 | 6 | 7 | 8 | 9 | 10 | 11 |
|---|---|---|---|---|---|---|---|---|---|---|---|---|---|
| Configured SMTC | | x | x | x | x | x | x | x | x | x | x | x | x |
| Rx 1 (TCI1) | SMTC | x | x | x | x | x | x | — | — | — | — | — | — |
| Rx 2 (TCI2) | SMTC | x | x | x | x | x | x | — | — | — | — | — | — |

As the measurement delay is prioritised, the 12 measurements (or 12 sets of measurements) are performed as early as possible concurrently within the consecutive SMTC occasions. In an alternative option, data reception is prioritised, and the measurements are performed in the last 6 time occasions of the SMTC window.

In another example, the time occasions of the SMTC windows are configured/associated with one Rx chain. This is shown in Table 5 below. In this example, the SMTC is associated with Rx2. In other examples, the SMTC is associated with Rx1 instead.

TABLE 5
Another example configuration for SMTC, wherein
the SMTC is associated with one of the Rx chains.

| SMTC occ. # | | 0 | 1 | 2 | 3 | 4 | 5 | 6 | 7 | 8 | 9 | 10 | 11 |
|---|---|---|---|---|---|---|---|---|---|---|---|---|---|
| Configured SMTC | | X | x | x | x | x | x | x | x | x | x | x | x |
| Rx 1 (TCI1) | SMTC | — | — | — | — | — | — | — | — | — | — | — | — |
| Rx 2 (TCI2) | SMTC | x | x | x | x | x | x | x | x | x | x | x | x |

Rx2 is configured to perform network measurements in time occasions 0 to 11, of the SMTC windows and will experience restrictions while performing measurements. Rx1 may perform data receptions during the SMTC window, without scheduling restrictions.

This example may be particularly useful for UEs with two Rx chains operating in the same antenna panel. In this case, one of the Rx chains is used for RRM measurements during the SMTC windows, while the other Rx chain receives data without scheduling restrictions.

Selecting appropriate options for configurations at the UE, from Tables 1 to 4, may depend on UE architecture and/or network configuration. In some examples, the UE may indicate, to the network, which option is used or preferred.

In some examples a combination of the configurations above may be applied at a UE.

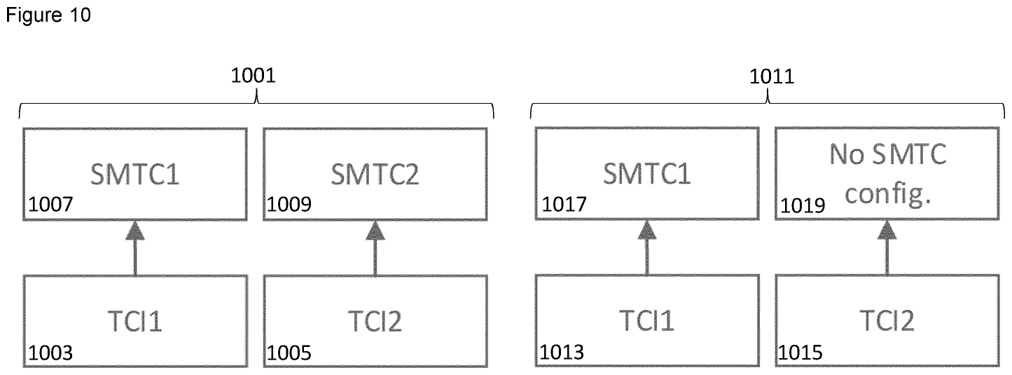

FIG. 10 shows a schematic representation of an association between SMTC configurations and transmission configuration information states.

For a first option 1001, there is a first TCI 1003 and a second TCI 1005. The first TCI 1003 may be considered to be/be associated with a first Rx chain (or first Rx element) of a UE. The second TCI 1005 may be considered to be/be associated with a second Rx chain (or second Rx element) of the UE. In the first option 1001, the first TCI 1003 is associated with a first SMTC 1007 (indicated by an arrow). The second TCI 1005 is associated with a second SMTC 1009 (indicated by an arrow). In examples, a UE receives the first SMTC 1007 and/or the second SMTC 1009 from a network. In other examples, the first SMTC 1007 and/or the second SMTC 1009 are preconfigured at the UE.

For a second option 1011, there is a first TCI 1013 and a second TCI 1015. The first TCI 1013 may be considered to be/be associated with a first Rx chain of a UE. The second TCI 1015 may be considered to be/be associated with a second Rx chain of the UE. In the second option 1011, the first TCI 1013 is associated with a first SMTC 1017 (indicated by an arrow). The second TCI 1005 is not associated any SMTC 1019 (indicated by an arrow). In examples, a UE receives the first SMTC 1017 from a network. In other examples, the first SMTC 1017 are preconfigured at the UE.

The association between an Rx chain (of a UE) and an SMTC configuration may mean that the RX chain uses a time window of the SMTC configuration for network measurements. In this time window for the Rx chain there is said to be scheduling restriction during the time window. The scheduling restrictions refer to the reception of data, as discussed previously. Therefore, if a further Rx chain is comprised within the UE, then during the time window, the UE is free to receive DL data without scheduling restrictions. The downlink data may be received without scheduling restrictions over the duration of the time window, such that downlink data is able to be received throughout the duration of the time window using the second receive element.

In some examples, a UE has a plurality of different antenna panels, wherein each antenna panel is located in a different area/part of the UE device. This is shown in FIG. 5, whereby an antenna panel is shown on each of the four sides of the device. Due to the location of the antenna panels, the angle/direction that the UE aims at is different for the different antenna panels. If first of the antenna panels is associated with/connected to a first Rx chain of the UE, and a second of the antenna panels is associated with/connected to a second Rx chain, then the angle/direction of signals associated with the first and second Rx chains is different. In this way, the first Rx chain may be used data and the second Rx chain may be used for network measurements, wherein the data and the network measurements are performed at different angles/directions. This is while the first Rx chain used for data is free from scheduling restrictions. The different angles/directions as discussed above may be referred to as spatial settings. The spatial settings of the associated Rx chains may therefore be different, depending of which antenna panel the Rx chain is connected to.

In some examples, an SMTC may be configured in a similar way as in 3GPP Rel-17. When more than one SMTC is configured, each SMTC is configured with an additional configuration per Rx chain or TCI states. This may be so that the UE can, in some conditions, split the SMTC configuration among the different active Rx chains (or TCI states). For the network, a benefit is that the UE can be scheduled in one of the Rx chains (TCI states) within the SMTC without scheduling restrictions/interruptions, while the UE is doing measurements using the other Rx chain.

In some examples, the splitting of the SMTC occurs when a UE has two Rx chains in active use. Otherwise, the UE measurement and performance falls back to using one Rx chain (similar to Table 1.1).

In examples such as the SMTC splitting/sharing of Table 1, the measurement period (i.e. the length of time that network measurements are being performed for) may not change, but the UE can be scheduled in different antenna panels accordingly, with and without scheduling restrictions known to network. This has the advantage that overall scheduling opportunities of the UE can be improved.

In examples such as the SMTC splitting/sharing of Table 2, the measurement period of the network measurements is unchanged compared to a single Rx chain UE assumption. However, the UE scheduling restriction is applied on a synchronised manner on both Rx chains (TCI states) while, at other time occasions of the SMTC, there are no scheduling restrictions on either of the Rx chains (Rx1 and Rx2). Hence, the UE can be scheduled on both Rx chains without restriction. For example, every second SMTC time occasion there is no restriction. This approach assumes that the UE can perform simultaneously using both Rx chains simultaneously (TCI states).

The example of SMTC splitting/sharing of Table 3 is similar to that of Table 2, but using a different measurement approach. In some examples, the UE may determine which option is more suitable. In other examples, the network informs the UE as to which configuration should be used. In other examples, the configuration depends on the UE capability. For example, the UE may provide an indication of the UE capability to the network. The network may then determine the suitable configuration based on the received indication. The indication from the UE may be whether the UE can measure simultaneously using two Rx chains, or measure using one Rx chain at a time (per SMTC time occasion).

With each of the SMTC splitting/sharing configurations above, the UE scheduling restrictions are reduced (i.e. scheduling opportunities are enhanced). Hence, the UE may experience increased scheduling opportunities and thereby a throughput increase, as well as an increase in overall network and system throughput.

In another example, different SMTCs may be configured as part of a MeasObjectNR which can be extended with a new field, which is named ‘perTCIsmtc’. It should be understood that in other examples, any suitable name for the new field may be given. In 5G NR, measurement objects (MeasObjectNR) are defined for both intra- and inter-frequency. Each measurement object indicates frequency/time location as well as subcarrier spacing of the reference signals to be measured.

The new field, perTCIsmtc, may contain two SMTC configurations that may be using different periodicity and/or different offset. Each new SMTC configuration may be be associated with a TCI state (or receive chain). Some example pseudocode for the configuration of MeasObjectNR with the perTCIsmtc field is shown below, wherein the additional information is shown in bold:

| | |
|---|---|
| MeasObjectNR ::= | SEQUENCE { |
| ssbFrequency | ARFCN-ValueNR |

OPTIONAL, -- Cond SSBorAssociatedSSB

| | |
|---|---|
| ssbSubcarrierSpacing | SubcarrierSpacing |

OPTIONAL, -- Cond SSBorAssociatedSSB

| | |
|---|---|
| smtc1 | SSB-MTC |

OPTIONAL, -- Cond SSBorAssociatedSSB

| | |
|---|---|
| smtc2 | SSB-MC2 |

OPTIONAL, -- Cond IntraFreqConnected
perTCIsmtc {

| | |
|---|---|
| PerTCIsmtc_A | SSB-MTC |
| PerTCIsmtc_B | SSB-MTC |

```
    }
...
}
PerTCIsmtc_A is associated with a first TCI state
PerTCIsmtc_B is associated with a second TCI state
    where
```

| | |
|---|---|
| SSB-MTC ::= | SEQUENCE { |
| periodicityAndOffset | CHOICE { |
| sf5 | INTEGER (0..4), |
| sf10 | INTEGER (0..9), |
| sf20 | INTEGER (0..19), |
| sf40 | INTEGER (0..39), |
| sf80 | INTEGER (0..79 |
| sf160 | INTEGER (0..159) |

},

| | |
|---|---|
| duration | ENUMERATED { sf1, sf2, sf3, sf4, sf5 } |

This code snippet is an example of how the per TCI SMTC configuration may be encoded. Once the feature is enabled, the UE may apply PerTCIsmtc_A for a first Rx chain of a UE, and PerTCIsmtc_B for a second Rx chain of the UE.

In some examples, the network indicates the splitting/sharing configuration to be used at the UE and/or how the Rx chain usage is to be applied.

In an example, the network indicates that every second SMTC time occasion is to be used by each Rx chain (or TCI state) every second time. A determination of which SMTC period is, at any time occasion, can be performed using any suitable manner. For example, using a frame number and a deterministic algorithm may be used for the determination. For example, the frame index of an SMTC time occasion may be used as a reference.

In an example, the UE indicates its capability to measure SMTC simultaneously using more than one Rx chain.

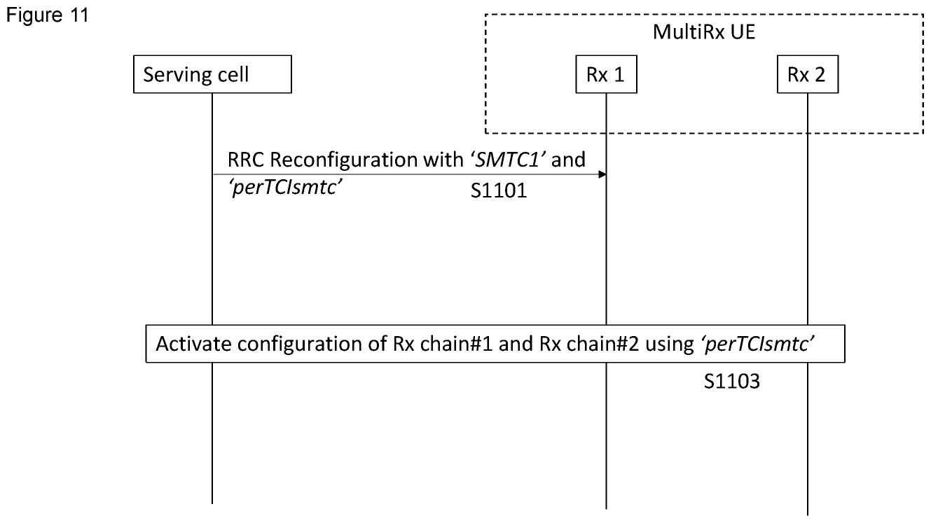

An example of a signalling diagram between a UE and a network is shown in FIG. 11.

FIG. 11 shows an example signalling diagram between a serving cell and a UE with multiple receive chains. The serving cell may be provided by a network node or base station (e.g. gNB). The network node may provide one or more further cells than the serving cell. In this example of FIG. 11 the UE has two Rx chains. In other examples, the UE may have more than two Rx chains.

At S1101, the serving cell provides a configuration message to the UE. The message may be an radio resource control (RRC) reconfiguration message. In other examples, other suitable message types are used.

The message comprises a first time window. The first time window may be a first SMTC (SMTC1). The SMTC1 may be part of a measurement object configuration. The message may indicate for the first SMTC to be used by the UE while the UE has a single Rx chain/TCI state active.

The message also comprises a perTCIsmtc configuration. The perTCIsmtc may be part of the measurement object configuration. The message may indicate for the perTCIsmtc to remain inactive until the UE has more than one Rx chain/TCI state active.

For example the message from the serving cell may be:

RRCReconfiguration(
MeasConfig/MeasObjectToAddModList/MeasObjectNR/SMTCI,
MeasConfig/MeasObjectToAddModList/MeasObjectNR/perTCIsmtc,
Wherein:
perTCIsmtc = {
-perTCIsmtc1
-perTCIsmtc2
}

The activation and deactivation of SMTC windows in the case of configuration of multiple SMTC windows (e.g. as seen in Table 2.1) may follow the TCI state activation. SMTC window activation may be explicitly signalled to UE with, for example, RRC, MAC or L1 messages. SMTC window activation may also be implicitly signalled by scheduling data on the associated TCI state.

At S1103, the serving cell requests an activation/activates a second Rx chain at the UE. Before the activation message, it is assumed that a single (first Rx chain) is active at the UE.

Following the request to activate/activation at the UE, the UE now has a first and a second Rx chain active. This means that a first TCI state and a second TCI state are active. Due to this, the UE now activates the perTCIsmtc configuration at the UE. As an example, the Rx chain (TCI) with the smaller index, i.e. first Rx chain, uses perTCIsmtc1, while the second RX chain uses perTCIsmtc2. In other examples, this may be the other way round.

In examples, the serving cell provides, to the UE, the configuration for a time window to perform network measurements in, and communicates, during the time window, with the UE by at least one of: providing signals for network measurements at the user equipment, and providing downlink data to the user equipment. In some examples, the communicating with the UE is by providing signals for network measurements using the serving cell of the network node, and communicating with the user equipment by providing downlink data to the user equipment using a second cell of the network node, at the same time during the time window.

In examples, the configuration for the time window comprises an indication for the UE to associate the time window with a first receive element of a user equipment.

In examples, the serving cell provides, to the UE, information associating the configuration of a time window for network measurement with a network transmit beam index for downlink.

In examples, the serving cell provides, to the UE, information associating the activation of the time window for network measurement and a network transmit beam index for downlink.

In examples, the serving cell provides, to the UE, a configuration for a further time window to perform network measurements in, wherein the configuration for the further time window comprises an indication for the user equipment to associate the further time window with a second receive element of a user equipment. The serving cell may then communicate, during the further time window, with the user equipment by providing signals for network measurements.

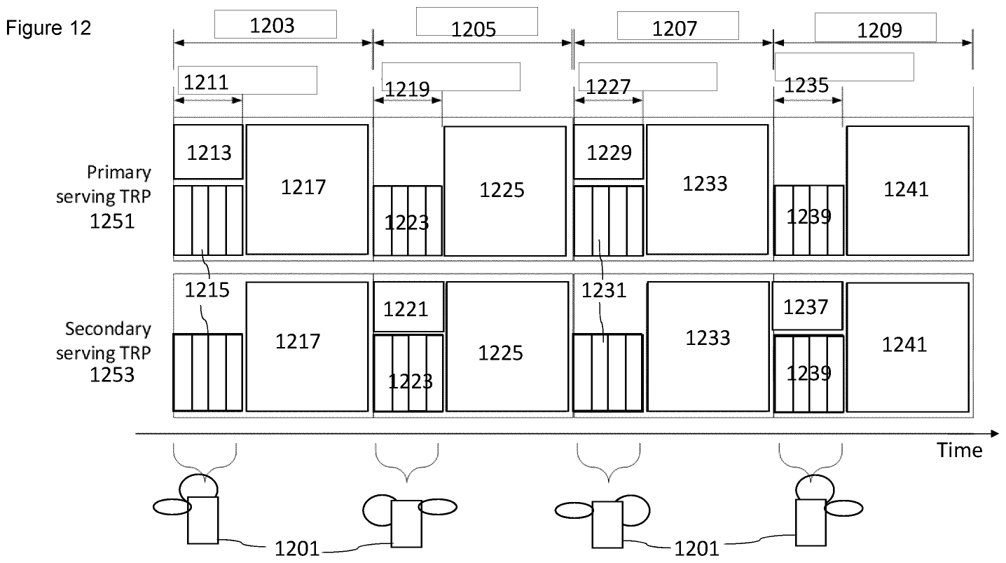

An advantage of the mechanism of FIG. 11 is illustrated in FIG. 12.

FIG. 12 shows a schematic representation of the simultaneous data receptions and measurements performance by a UE with multiple receive chains.

FIG. 12 shows the operation of a UE 1201 in four time periods 1203, 1205, 1207, 1209. The UE 1201 has the same architecture as the UE 501 illustrated in FIG. 5. In this way, the UE 1201 has two Rx chains and four antenna panels (not shown).

In each of the four time periods 1203, 1205, 1207, 1209, the UE 1201 is performing a data reception, and also performing a measurement. Each time period may be an SMTC period. Each time period comprises a time window for measurements. Each time window may be an SMTC window.

Within the first time period 1203 there is a first time window 1211. During the first time window 1211 the UE 1201 is: i) receiving data 1213 from a primary serving TRP 1251, and ii) performing measurements. The UE 1201 is able to receive (and decode) data using a first Rx chain without UE restrictions such as scheduling restrictions, and perform measurements using a second Rx chain. The measurements may be of neighbour cells, for example (similar to FIGS. 9a to 9c). There is also shown SSB bursts 1215 within the first time window 1211. Outside of the first time window 1211, within the first time period, the UE 1201 receives data 1217 from both the primary serving TRP 1251 and a secondary serving TRP 1253.

Within the second time period 1205 there is a second time window 1219. During the second time window 1219 the UE 1201 is: i) receiving data 1221 from the secondary serving TRP 1253, and ii) performing measurements. The UE 1201 is able to receive (and decode) data using a second Rx chain without UE restrictions such as scheduling restrictions, and perform measurements using a first Rx chain. The measurements may be of neighbour cells, for example (similar to FIGS. 9a to 9c). There is also shown SSB bursts 1223 within the second time window 1219. Outside of the first time window 1205, within the second time period 1205, the UE 1201 receives data 1225 from both the primary serving TRP 1251 and a secondary serving TRP 1253.

Within the third time period 1207 there is a third time window 1227. During the third time window 1227 the UE 1201 is: i) receiving data 1229 from a primary serving TRP 1251, and ii) performing measurements. The UE 1201 is able to receive (and decode) data using a first Rx chain without UE restrictions such as scheduling restrictions, and perform measurements using a second Rx chain. The measurements may be of neighbour cells, for example (similar to FIGS. 9a to 9c). There is also shown SSB bursts 1231 within the third time window 1227. Outside of the third time window 1227, within the third time period 1207, the UE 1201 receives data 1233 from both the primary serving TRP 1251 and a secondary serving TRP 1253.

Within the fourth time period 1209 there is a fourth time window 1235. During the fourth time window 1235 the UE 1201 is: i) receiving data 1237 from the secondary serving TRP 1253, and ii) performing measurements. The UE 1201 is able to receive (and decode) data using a second Rx chain without UE restrictions such as scheduling restrictions, and perform measurements using a first Rx chain. The measurements may be of neighbour cells, for example (similar to FIGS. 9a to 9c). There is also shown SSB bursts 1239 within the fourth time window 1235. Outside of the fourth time window 1235, within the fourth time period 1209, the UE 1201 receives data 1241 from both the primary serving TRP 1251 and a secondary serving TRP 1253.

In this example of FIG. 12, the UE receives downlink data using the two Rx chains from different TRPs 1251, 1253. Outside of the SMTC time windows a network is able to schedule in DL to the UE using both Rx chains/TCI states. The behaviour of the UE 1201 is different when considering the time occasions/symbols inside the SMTC time windows 1211, 1219, 1227, 1235. When considering UE behaviour in some known systems, the network would not be able to schedule data in the SSB symbols and/or the symbols around the SSB.

The association between at least one of the Rx chains and the SMTC time windows enables the UE to be scheduled during that SMTC window without scheduling restrictions, on at least one of the active Rx chains (TCI states). This is achieved by enabling the network to know when a UE is assumed to have restrictions on a given Rx chain due to measurements being performed.

It also enables enhanced scheduling possibilities of the UE, such that the number of time occasions (e.g., symbols) wherein the UE is assumed to not be available to receive and/or transmit data due to scheduling restrictions, is minimized.

When analysing this from network perspective, in some situations, several UEs will have the same or similar SMTC configurations. Therefore, when looking at known systems, the scheduling restrictions are common for several UEs, and the network has to schedule all the UEs sharing SMTC configuration on the same OFDM symbols. When applying the example mechanisms as discussed above, the overall network performance can be greatly optimized, since those symbols can be used by multi-receiver chain UEs that support those optimized scheduling restrictions.

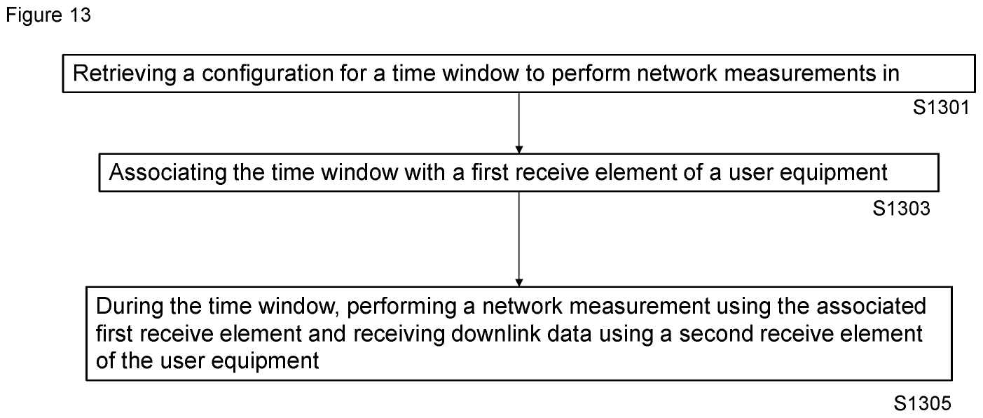

FIG. 13 shows an example method flow performed by an apparatus. The apparatus may be comprised within a user equipment.

In S1301, the method comprises retrieving a configuration for a time window to perform network measurements in.

In S1303, the method comprises associating the time window with a first receive element of a user equipment.

In S1305, the method comprises during the time window, performing a network measurement using the associated first receive element and receiving downlink data using a second receive element of the user equipment

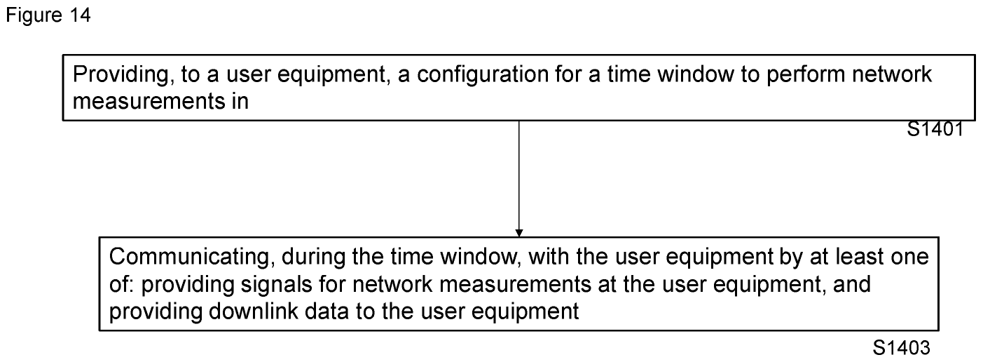

FIG. 14 shows an example method flow performed by an apparatus. The apparatus may be comprised within a network node. In an example, the network node is base station. In some examples, the network node provides a serving cell.

In S1401, the method comprises providing, to a user equipment, a configuration for a time window to perform network measurements in.

In S1403, the method comprises communicating, during the time window, with the user equipment by at least one of: providing signals for network measurements at the user equipment, and providing downlink data to the user equipment

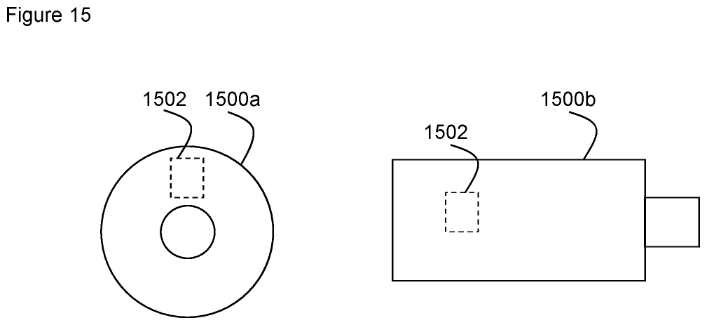

FIG. 15 shows a schematic representation of non-volatile memory media 1500a (e.g. computer disc (CD) or digital versatile disc (DVD)) and 1500b (e.g. universal serial bus (USB) memory stick) storing instructions and/or parameters 1502 which when executed by a processor allow the processor to perform one or more of the steps of the methods of FIG. 13 and/or FIG. 14.

It is noted that while the above describes example embodiments, there are several variations and modifications which may be made to the disclosed solution without departing from the scope of the present invention.

The examples may thus vary within the scope of the attached claims. In general, some embodiments may be implemented in hardware or special purpose circuits, software, logic or any combination thereof. For example, some aspects may be implemented in hardware, while other aspects may be implemented in firmware or software which may be executed by a controller, microprocessor or other computing device, although embodiments are not limited thereto. While various embodiments may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The examples may be implemented by computer software stored in a memory and executable by at least one data processor of the involved entities or by hardware, or by a combination of software and hardware. Further in this regard it should be noted that any procedures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD.

The term “non-transitory”, as used herein, is a limitation of the medium itself (i.e. tangible, not a signal) as opposed to a limitation on data storage persistency (e.g. RAM vs ROM).

As used herein, “at least one of the following: <a list of two or more elements>” and “at least one of: <a list of two or more elements>” and similar wording, where the list of two or more elements are joined by “and”, or “or”, mean at least any one of the elements, or at least any two or more of the elements, or at least all of the elements.

The memory may be of any type suitable to the local technical environment and may be implemented using any suitable data storage technology, such as semiconductor-based memory devices, magnetic memory devices and systems, optical memory devices and systems, fixed memory and removable memory. The data processors may be of any type suitable to the local technical environment, and may include one or more of general purpose computers, special purpose computers, microprocessors, digital signal processors (DSPs), application specific integrated circuits (ASIC), gate level circuits and processors based on multi core processor architecture, as non-limiting examples.

Alternatively, or additionally some examples may be implemented using circuitry. The circuitry may be configured to perform one or more of the functions and/or method steps previously described. That circuitry may be provided in the base station and/or in the communications device.

As used in this application, the term “circuitry” may refer to one or more or all of the following:
(a) hardware-only circuit implementations (such as implementations in only analogue and/or digital circuitry);
(b) combinations of hardware circuits and software, such as:
   (i) a combination of analogue and/or digital hardware circuit(s) with software/firmware and
   (ii) any portions of hardware processor(s) with software (including digital signal processor(s)), software, and memory(ies) that work together to cause an apparatus, such as the communications device or base station to perform the various functions previously described; and
(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example integrated device.

The foregoing description has provided by way of exemplary and non-limiting examples a full and informative description of some embodiments. However, various modifications and adaptations may become apparent to those skilled in the relevant arts in view of the foregoing description, when read in conjunction with the accompanying drawings and the appended claims. However, all such and similar modifications of the teachings will still fall within the scope as defined in the appended claims.

1. An apparatus comprising:
at least one processor, and at least one memory storing instructions that, when executed by the one or more processors, cause the apparatus to at least perform:
retrieving a configuration for a time window to perform network measurements in;
associating the time window with a first receive element of a user equipment; and,
during the time window, performing a network measurement using the associated first receive element and receiving downlink data using a second receive element of the user equipment.

2. The apparatus according to claim 1, wherein the downlink data is received without scheduling restrictions over the duration of the time window, such that downlink data is able to be received throughout the duration of the time window using the second receive element.

3. The apparatus according to claim 1, wherein the apparatus is further caused to at least perform:
receiving, from a network node, information associating the configuration of a time window for network measurement with a network transmit beam index for downlink.

4. The apparatus according to claim 1, wherein the apparatus is further caused to at least perform:
receiving, from a network node, information associating the activation of the time window for network measurement and a network transmit beam index for downlink.

5. The apparatus according to claim 1, wherein the apparatus is further caused to at least perform:
receiving a configuration for a further time window to perform network measurements in;
associating the further time window with the second receive element of the user equipment; and
performing a network measurement during the further time window using the associated second receive element.

6. The apparatus according to claim 1, wherein the time window comprises a plurality of time occasions.

7. The apparatus according to claim 6, wherein the apparatus is further caused to at least perform:
assigning each of the plurality of time occasions of the time window for at least one of: the receiving of data, and the performing of network measurements; and
performing at least one of: i) the reception data using at least one of: the first receive element, and the second receive element, and ii) network measurements using at least one of: the first receive element and the second receive element, during the time window, according to the assigning in each of the plurality of time occasions.

8. The apparatus according to claim 7, wherein the associating comprises:
associating the time window with: i) the first receive element of a user equipment, and ii) a second receive element of the user equipment.

9. The apparatus according to claim 7, wherein the assigning comprises:
assigning each of the plurality of time occasions of the time window for at least one of: the reception of data, and the performing of network measurements, using at least one of: the first receive element, and the second receive element of the user equipment.

10. The apparatus according to claim 7, wherein, for a time occasion of the plurality of time occasions, one of the first receive element and the second receive element is assigned for the reception of data, and the other of the first receive element and the second receive element is assigned for performing of network measurements.

11. The apparatus according to claim 7, wherein, for a time occasion of the plurality of time occasions, both the first receive element and the second receive element are assigned for one of: the reception of data, and the performing of network measurements.

12. The apparatus according to claim 7, wherein the assignments for the reception of data, and the performing of network measurements, for both the first receive element and the second receive element, alternate between each time occasion in the time window.

13. The apparatus according to claim 7, wherein, for the time window, one of the first receive element and the second receive element is assigned for one of: the reception of data, and the performing of network measurements.

14. The apparatus according to claim 1, wherein the time window comprises a synchronisation signal block-based measurement timing configuration, SMTC, window.

15. The apparatus according to claim 1, wherein the retrieving comprises:
receiving, from a network node, the configuration for the time window in a radio resource control reconfiguration message,
wherein the configuration comprises information of the first receive element, and an indication that the first receive element is associated to network measurements, and
wherein the configuration comprises information of the second receive element, and an indication that the second receive element is associated to downlink data reception.

16. The apparatus according to claim 1, wherein one of: the apparatus is for the user equipment, the apparatus is comprised in the user equipment, and the apparatus is the user equipment.

17-23. (canceled)

24. A method comprising:
retrieving a configuration for a time window to perform network measurements in;
associating the time window with a first receive element of a user equipment; and
during the time window, performing a network measurement using the associated first receive element and receiving downlink data using a second receive element of the user equipment.

25. (canceled)

26. The method according to claim 24, wherein the method comprises:
receiving, from a network node, information associating the configuration of a time window for network measurement with a network transmit beam index for downlink.

27. The method according to claim 24, wherein the method comprises:
receiving, from a network node, information associating the activation of the time window for network measurement and a network transmit beam index for downlink.

28. The method according to claim 24, wherein the method comprises:
receiving a configuration for a further time window to perform network measurements in;
associating the further time window with the second receive element of the user equipment; and
performing a network measurement during the further time window using the associated second receive element.

29-50. (canceled)
